(19) United States
(12) Patent Application Publication
(10) Pub. No.: US 2018/0297090 A1
(43) Pub. Date: Oct. 18, 2018

(54) AIR VENT SYSTEM

(71) Applicant: GULFSTREAM INC., Cambridge (CA)

(72) Inventors: Minh Sang Tran, Cambridge (CA); Chris Alexander, Cambridge (CA)

(21) Appl. No.: 15/956,550

(22) Filed: Apr. 18, 2018

Related U.S. Application Data
(60) Provisional application No. 62/486,680, filed on Apr. 18, 2017.

(51) Int. Cl. B08B 15/04

(52) U.S. Cl. CPC B08B 15/04

(57) ABSTRACT

Apparatus which forms part of the system includes a receiver, a body and a cap. The receiver defines a bore that has a threaded interior surface. The body: defines an interior cavity; and has an exterior surface. The exterior surface: defines an aperture that communicates with the cavity; and is adapted for threaded engagement with the bore such that, when the body is operatively positioned within the receiver, rotation of the body causes movement of the body between a retracted position wherein the vent is disposed at least substantially interiorly of the receiver and an extended positioned wherein the vent is disposed at least substantially exteriorly of the receiver. The cap is mounted to the body and adapted, when the body is disposed in the retracted position, to occlude the bore.

### RELATED APPLICATIONS

This application claims priority benefit of U.S. Provisional Application Ser. No. 62/486,680 filed 18 Apr. 2017; the contents of which are hereby incorporated by reference.

### FIELD OF THE INVENTION

The invention relates to the field of foot care.

### BACKGROUND OF THE INVENTION

It is known that, in the use of foot spas, air quality in the immediate vicinity can be compromised. Accordingly, it is known to place the intakes of air cleaners in the vicinity of foot spas. In some foot spas, apertures are provided adjacent the basin.

### SUMMARY OF THE INVENTION

Forming one aspect of the invention is apparatus comprising a receiver, a body and a cap. The receiver defines a bore that has a threaded interior surface.

The body: defines an interior cavity; and has an exterior surface. The exterior surface: defines an aperture that communicates with the cavity; and is adapted for threaded engagement with the bore such that, when the body is operatively positioned within the receiver, rotation of the body causes movement of the body between a retracted position wherein the vent is disposed at least substantially interiorly of the receiver and an extended positioned wherein the vent is disposed at least substantially exteriorly of the receiver. The cap is mounted to the body and is adapted, when the body is disposed in the retracted position, to occlude the bore.

Further details and advantages of the invention will become apparent upon reviewing the following detailed description and the appended drawings, the latter being briefly described hereinafter.

### BRIEF DESCRIPTION OF THE DRAWINGS

FIG. 1 is a perspective view of apparatus according to an exemplary embodiment of the invention, in a retracted position;

FIG. 2 is an exploded view of the structure of FIG. 1;

FIG. 3 is a view similar to FIG. 1, in an extended position;

FIG. 4 is a side view of the structure of FIG. 1;

FIG. 5 is a view along section 5-5 of FIG. 4;

FIG. 6 is a perspective view of a prior art foot spa;

FIG. 7 is a view similar to FIG. 6, showing a prior art foot spa modified for use with apparatus of the exemplary embodiment;

FIG. 8 is a view showing the structure of FIG. 1 in use with the structure of FIG. 7

FIG. 9 is a view similar to FIG. 8;

FIG. 10 is an enlarged view of the structure of encircled area 10 of FIG. 8;

FIG. 11 is an enlarged view of the structure of encircled area 11 of FIG. 8; and

FIG. 12 is a view showing a plurality of the structures of FIG. 1 in use with a plurality of the structures of FIG. 7.

### DETAILED DESCRIPTION OF THE EXEMPLARY EMBODIMENT

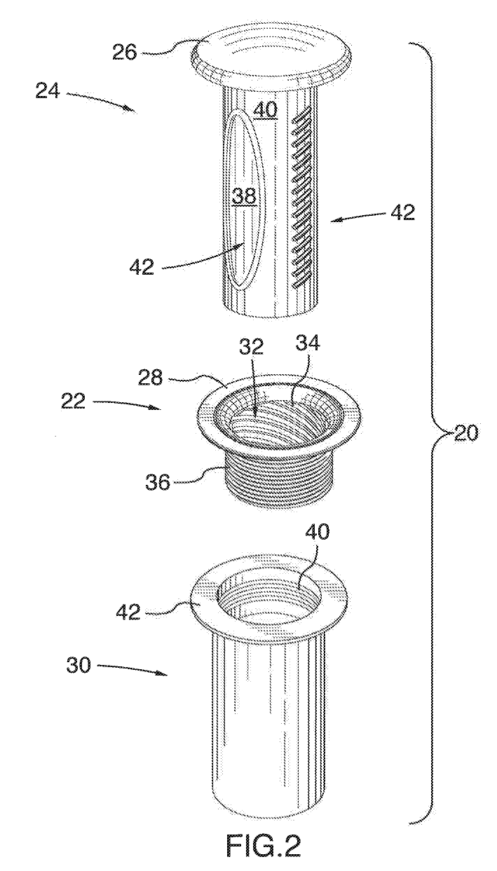

The components of the exemplary embodiment are shown in FIG. 2 and will be seen to include a receiver 22, a body 24, a cap 26, a flange 28 and a mount 30.

The receiver 22 is tubular, defines a bore 32 that has a threaded interior surface 34 and has a threaded exterior surface 36.

The flange 28 is disposed in surrounding relation to the receiver 22 and formed integrally therewith.

The body 24: defines an interior cavity 38; is exteriorly threaded; and has an exterior surface 40, the exterior surface: defining a pair of elongate apertures 42 that communicate with the cavity 38, the apertures 42 of the pair being disposed on opposite sides of the body 24.

The cap 26 is mounted to the body 24 and formed integrally therewith.

The mount 30 is annular, has an interior threaded surface 40 and terminates in a boss 42.

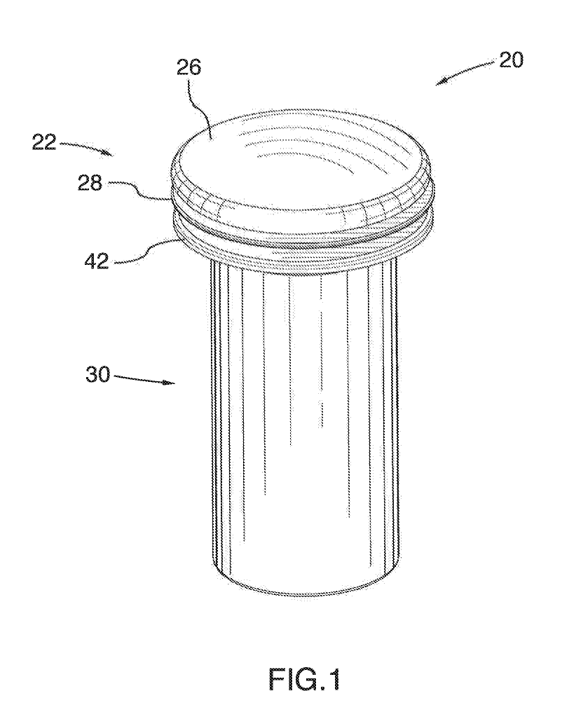

FIG. 1 shows the components as assembled for use and in a fully retracted position of the body.

Herein it will be seen that, so assembled, the body 24 is threadingly engaged in the bore 32, the flange 28 receives the cap 26 in tight-fitting relation, the cap 26 occludes the bore 32, the receiver 22 is threadingly received by the mount 30 and the apertures 42 are disposed interiorly of the receiver 22, that is, on the side of the flange 28 from which the receiver 22 projects.

The threaded engagement between the body 24 and the bore 32 is such that, when the body 24 is operatively positioned within the receiver 22 as shown, rotation of the body 24 causes the body 24 to move outwardly relative to the receiver 22, that is, beyond the flange 28, to expose the apertures 42.

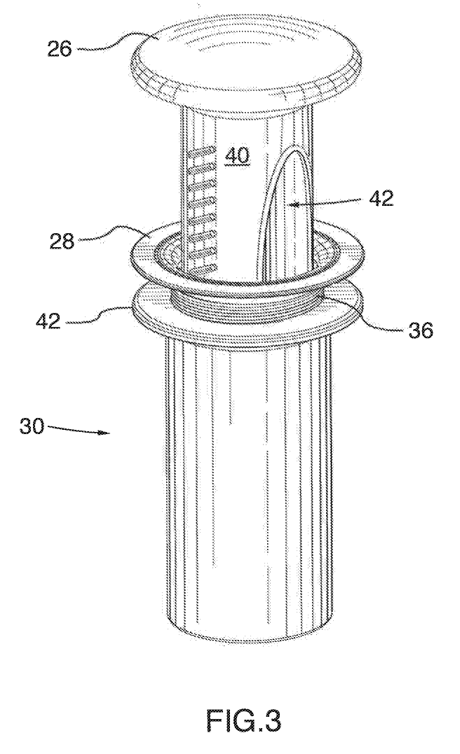

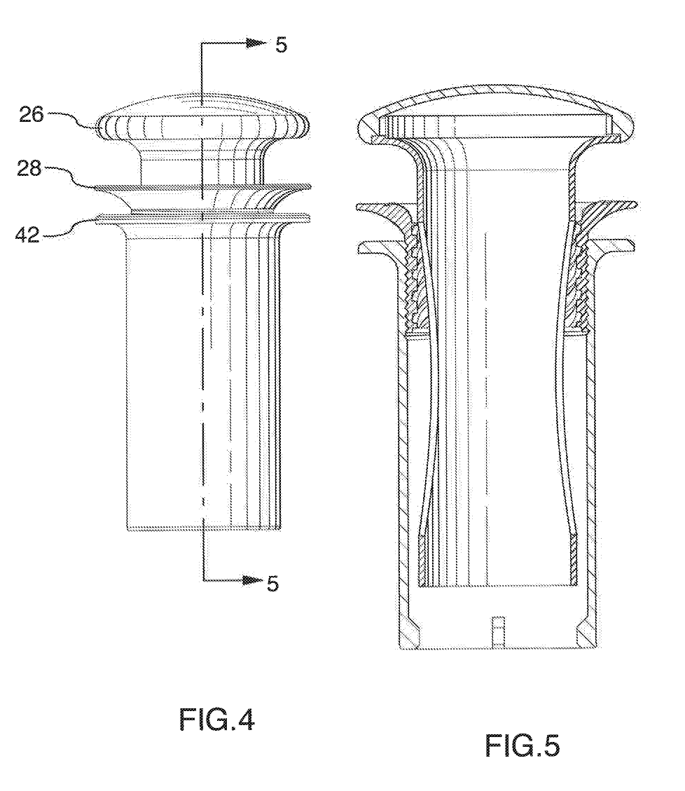

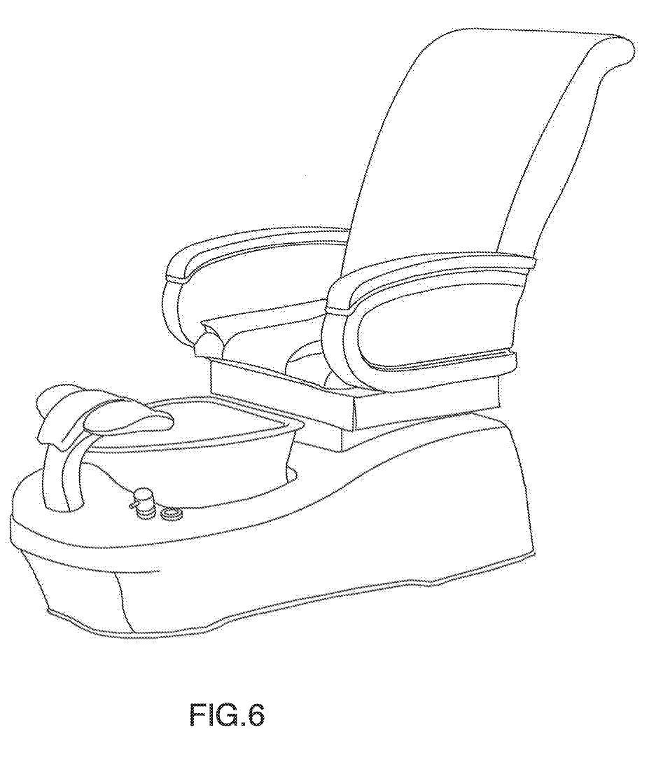

In the fully extended position shown in FIG. 3, the apertures 42 are disposed substantially exteriorly of the receiver 22 (beyond the flange 28).

The apparatus 20 can be used to provide ventilation in foot spas.

FIG. 6 shows a prior art foot spa 100 with which the apparatus 20 can be used.

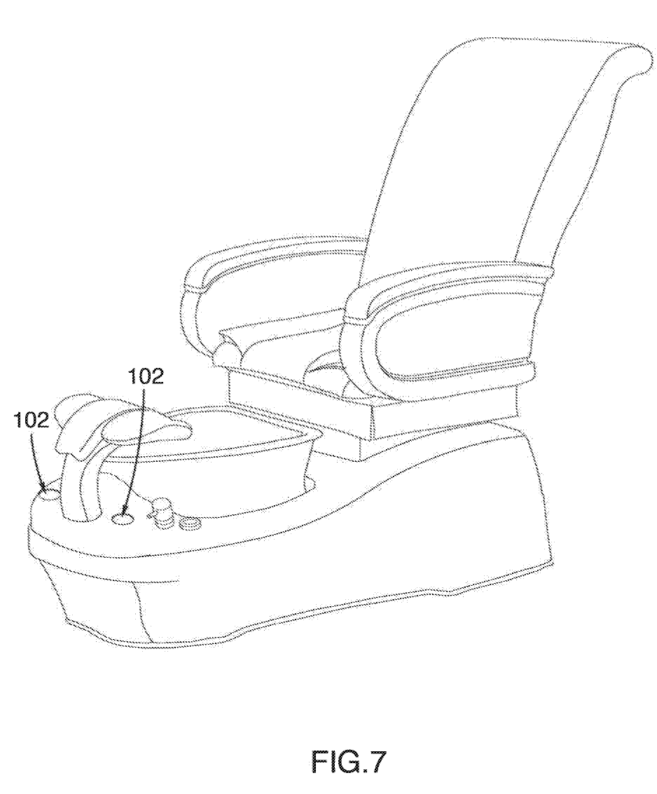

To use the apparatus 20, holes 102 are drilled in the foot spa 100, as indicated by FIG. 7.

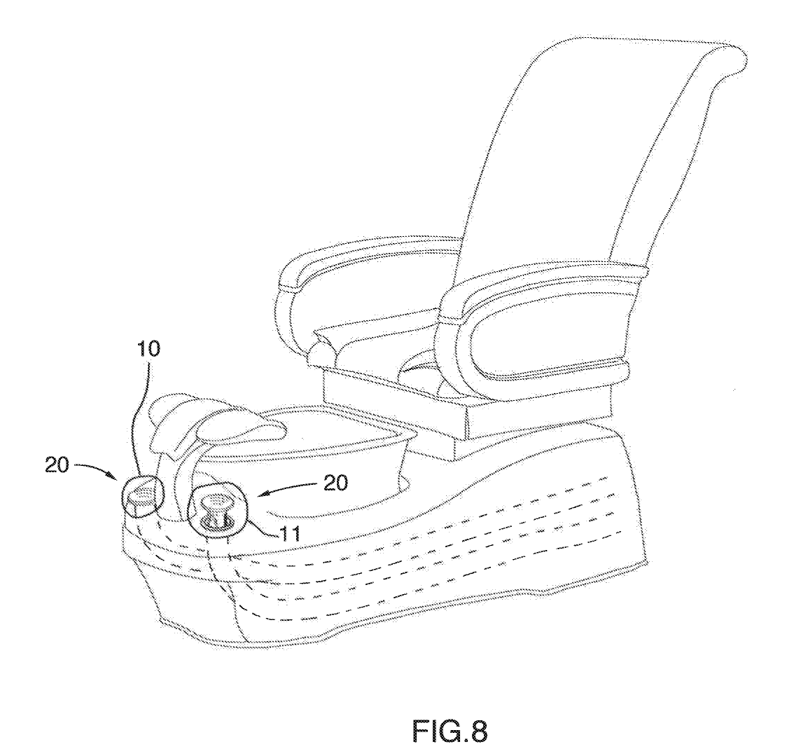

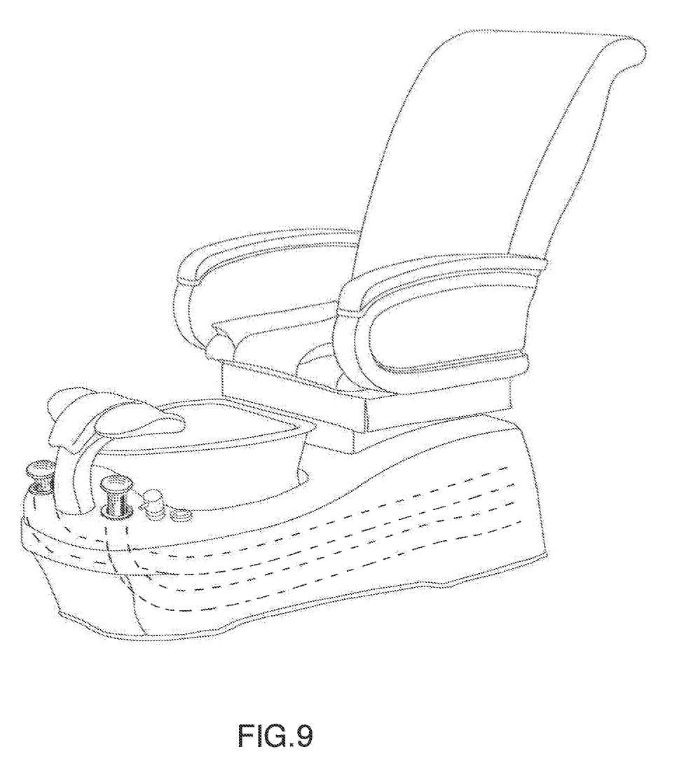

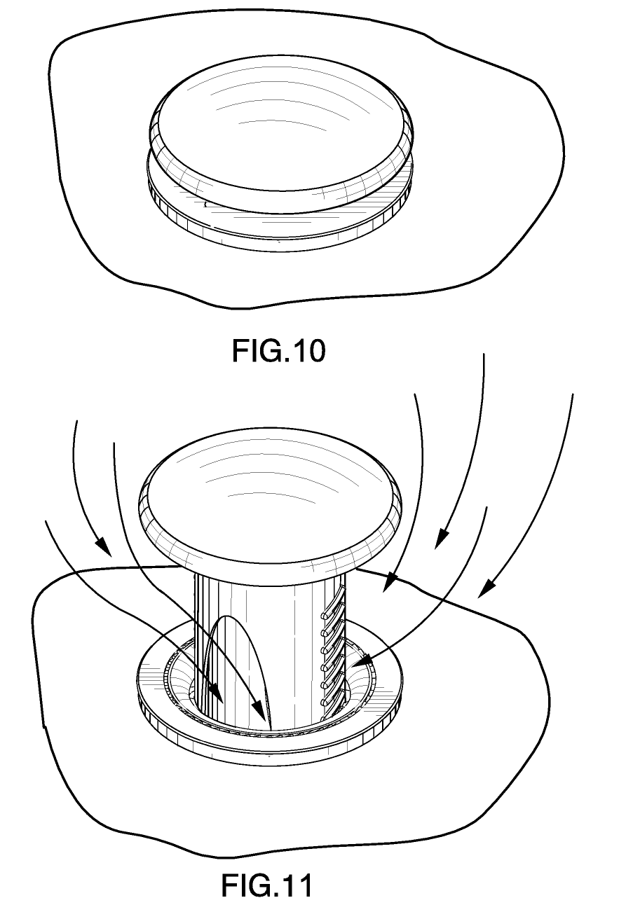

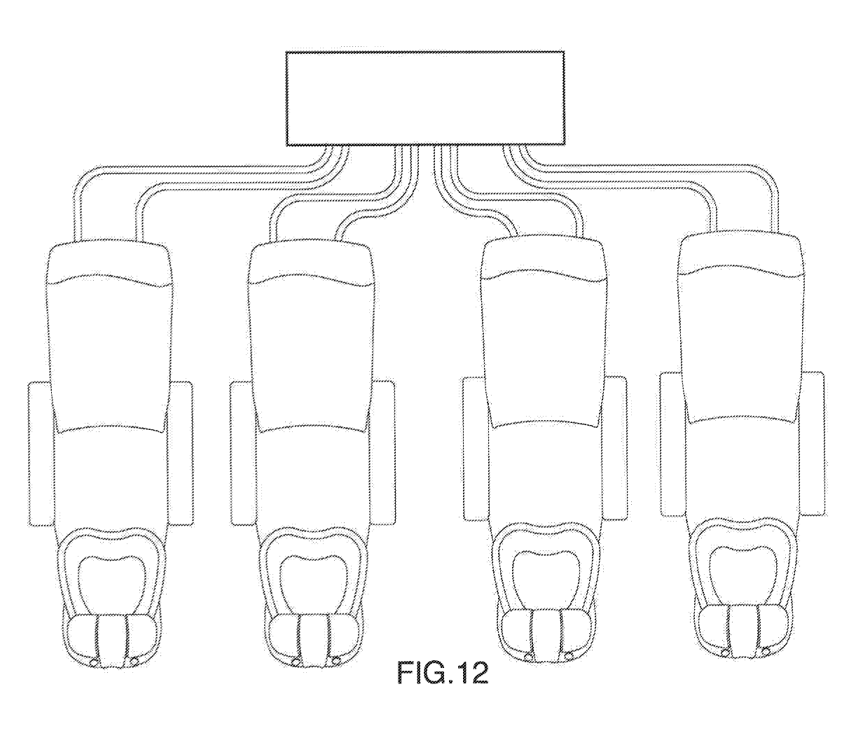

Thereafter, as indicated by FIG. 8 a receiver is fitted through each hole until such time as the flange is flush with the spa surface the mount is threaded upon the receiver from the interior of the spa until such time as the spa shell is sandwiched between the boss and the flange, to secure the receiver in place; and air intake lines are secured to the mount in any conventional fashion.

FIG. 8 shows two of the apparatus fitted to the foot spa, one in the fully retracted position and one in the fully extended position. However, any number of apparatus can be provided, and deployed in any position between and inclusive of the fully extended and fully retracted position, depending upon need.

The apparatus has significant advantage, especially in the context of retrofitting banks of existing foot spas in salons or the like.

For example, only FIG. 11 shows four foot spas, each provided with two of the apparatus, all coupled to a central air cleaner 104 by intake lines 106.

The use of a single air cleaner for multiple devices has cost advantage in terms of capital cost. As well, the ability of each apparatus to be selectively opened and closed has advantage in terms of sizing and energy use. In many salon settings, the chairs are used intermittently and ventilation is not always required, so a relatively small air handler can be used and will, except in unusual situations, function well.

Whereas a specific embodiment is herein shown and described, variations are possible. Accordingly, the invention should be understood to be limited only by the accompanying claims, purposively construed.

1. Apparatus comprising:
a receiver defining a bore that has a threaded interior surface;
a body
defining an interior cavity; and
having an exterior surface, the exterior surface
defining an aperture that communicates with the cavity
being adapted for threaded engagement with the bore such that, when the body is operatively positioned within the receiver, rotation of the body causes movement of the body between a retracted position wherein the vent is disposed at least substantially interiorly of the receiver and an extended positioned wherein the vent is disposed at least substantially exteriorly of the receiver;
a cap mounted to the body and adapted, when the body is disposed in the retracted position, to occlude the bore.

2. Apparatus according to claim 1, wherein the exterior surface defines a pair of apertures that communicate with the cavity.

3. Apparatus according to claim 2, wherein the apertures of the pair are disposed on opposite sides of the body.

4. Apparatus according to claim 1, wherein the aperture is elongate.

5. Apparatus according to claim 1, further comprising a flange disposed in surrounding relation to the receiver and adapted to receive the cap in tight-fitting relation when the body is in the retracted position.

6. Apparatus according to claim 1, wherein the body is exteriorly threaded.

7. Apparatus according to claim 6, further comprising an annular mount having an interior surface adapted to receive the body in threaded relation.
